(19) United States
(12) Patent Application Publication
(10) Pub. No.: US 2025/0259105 A1
(43) Pub. Date: Aug. 14, 2025

(54) METHOD FOR QUALIFYING A MACHINE LEARNING MODEL

(71) Applicant: Robert Bosch GmbH, Stuttgart (DE)

(72) Inventors: Roland Norden, Kornwestheim (DE); David Reeb, Renningen (DE); Ernst Kloppenburg, Ditzingen (DE); Konrad Groh, Stuttgart (DE); Sven Peter, Heidelberg (DE); Thomas Spieker, Weissach (DE)

(21) Appl. No.: 19/047,276

(22) Filed: Feb. 6, 2025

(30) Foreign Application Priority Data
Feb. 9, 2024 (DE) 10 2024 201 221.1

(51) Int. Cl. G06N 20/00

(52) U.S. Cl. CPC G06N 20/00

(57) ABSTRACT

A method for qualifying a trained machine learning model. The method includes receiving a trained machine learning model, determining one or more model behavior features, performing an evaluation of a test dataset based on the test data criteria, and determining a qualification result based on the one or more model behavior features and the evaluation of the test dataset.

### BACKGROUND INFORMATION

More and more, the focus of various technical areas is the development and use of machine learning methods and associated models. Their use extends to a plurality of applications, including autonomous driving, robotics, medical diagnostics, speech recognition, tools, household products, and many more. The trustworthiness and quality of such models are crucial, in particular when they are used in safety-critical areas and when errors in the function of the model can have serious consequences.

The evaluation of machine learning models (ML models) and the assessment of their performance are central aspects in the development and application of such systems. The qualitative assessment of ML models is carried out on the basis of a validation dataset and a test dataset. These datasets are usually obtained by randomly dividing a total dataset into a training dataset, a validation dataset, and a test dataset, often according to a heuristic division ratio. The resulting test dataset is usually checked for suitability on the basis of experts.

After the model has been trained on the training data, it is usually tested on the validation data in order to see how well it generalizes. This can, for example, make it possible to detect overfitting or to identify the best combination of hyperparameters (e.g., learning rate, number of layers). Test data are a separate and independent dataset used for the final assessment of model performance after the model has been optimized with the training data and validation data. The test data were not presented to the model during the training process, and they are used to assess the model's ability to generalize to new, unknown data.

In addition to quantitative performance criteria used in assessing ML models, experts also play an important role. Their experience and knowledge provide in-depth insight into the trustworthiness and quality of models. Experts use checklists to assess qualitative criteria that are crucial for the trustworthiness of ML models.

For a comprehensive assessment of ML models, statements must be made about the desired behavior of the ML model and the expected conditions during operation. For ML models, there are usually only incomplete specifications available. Assumptions about the desired behavior and the boundary conditions during operation are usually indirectly confirmed by visual inspection of samples and the approval of experts.

In light of the growing importance of ML models and their diverse applications, there is an urgent need for reliable assessment methods in order to ensure that these models meet the required quality and trustworthiness standards.

### SUMMARY

A first general aspect of the present invention relates to a method for qualifying a trained machine learning model. According to an example embodiment of the present invention, the method comprises receiving a trained machine learning model, determining one or more model behavior features, performing an evaluation of a test dataset on the basis of one or more test data criteria, and determining a qualification result on the basis of the one or more model behavior features and the evaluation of the test dataset.

A second general aspect of the present invention relates to a computer system that is designed to execute the method for qualifying a trained machine learning model according to the first general aspect of the present invention (or an embodiment thereof).

A third general aspect of the present disclosure relates to a computer program that is designed to execute the method for qualifying a trained machine learning model according to the first general aspect of the present invention (or an embodiment thereof).

A fourth general aspect of the present disclosure relates to a computer-readable medium or signal that stores and/or contains the computer program according to the third general aspect of the present invention (or an embodiment thereof).

The method according to the first general aspect of the present invention (or an embodiment thereof) proposed in this disclosure can be used to provide a method for qualifying a trained machine learning model (ML model). These methods can help minimize potential risks and uncertainties in the application of ML models while making development and implementation more efficient in shortened development cycles. In examples, the qualification method can help to implement the approval of ML models with regard to safety goals, compliance with legal provisions, and/or operational risk. A further advantage can be that the method can be used within the framework of various technical functions and systems, such as autonomous driving functions, control unit functions in vehicles, such as control unit functions that replace physical sensors, calculate correction values or calculate abstract system states, (cloud-based) monitoring of vehicle fleets, and/or ML-based systems in the area of tool products and/or household products.

The techniques of the present invention can contribute to standardization in the qualification of ML models. Different ML model architectures can be qualified by means of the disclosed techniques. A further advantage can be that the standardized approach can be used to automate the qualification of ML models, for example in a computer-implemented manner. In examples, industrial self-certification can be made possible. This can include that ML models that are integrated in complex and specific system environments and that could only be replicated by external certification bodies with great technical and time-consuming effort can certify themselves within the existing (target) system environment. Furthermore, the comparability and reproducibility of ML models in different products and/or product generations can be improved. A uniform definition of test data criteria allows the uniform use of reference models to qualify the test dataset. The techniques of the present disclosure can make modular implementation of the method possible and can make it possible to add additional model behavior features and/or test data criteria related to new developments and domain properties. The method can help to reduce (safety-related) technical risks when using ML models in technical systems.

Some terms are used in the present disclosure in the following way:

A “machine learning model” can comprise any file that is trained to learn certain patterns in datasets and to obtain insights and predictions from these patterns. A machine learning model can be trained, for example, using supervised learning, unsupervised learning, reinforcement learning, semi-supervised learning, and/or transfer learning. A machine learning model can comprise, for example, a linear regression model, a logistic regression model, a support vector machine (SVM), a k-nearest neighbors classifier, decision trees and random forests, a k-means clustering model, a neural network such as a recurrent neural network (RNN), a long short-term memory network (LSTM), and/or a transformer model. Furthermore, a machine learning model can comprise algorithms for Q-learning, linear interpolation, nearest neighbor interpolation, and/or principal component analysis.

A “vehicle” can be any device that transports passengers and/or freight. A vehicle can be a motor vehicle (for example, a passenger car or a truck) but also a rail vehicle. A vehicle can also be a motorized two-wheeler or three-wheeler. However, floating and flying devices can also be vehicles. Vehicles can be assisted or can operate at least partially autonomously or autonomously.

### BRIEF DESCRIPTION OF THE DRAWINGS

FIG. 1A to 1B schematically illustrate a method for qualifying a trained machine learning model, according to an example embodiment of the present invention.

FIG. 2 schematically illustrates an exemplary qualification matrix according to one or more embodiments of the present disclosure.

### DETAILED DESCRIPTION OF EXAMPLE EMBODIMENTS

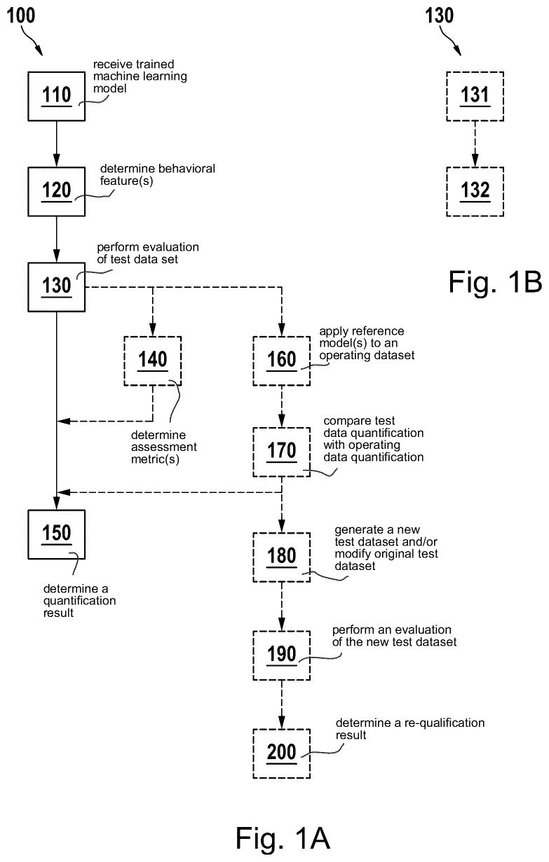

FIG. 1A and FIG. 1B are flowcharts that comprise possible method steps of the method 100 for qualifying a trained machine learning model. The method 100 for qualifying a trained machine learning model comprises receiving 110 a trained machine learning model. The method furthermore comprises determining 120 one or more model behavior features 13. The method furthermore comprises performing 130 an evaluation of a test dataset on the basis of one or more test data criteria 14. The method furthermore comprises determining 150 a qualification result on the basis of the one or more model behavior features 13 and the evaluation of the test dataset.

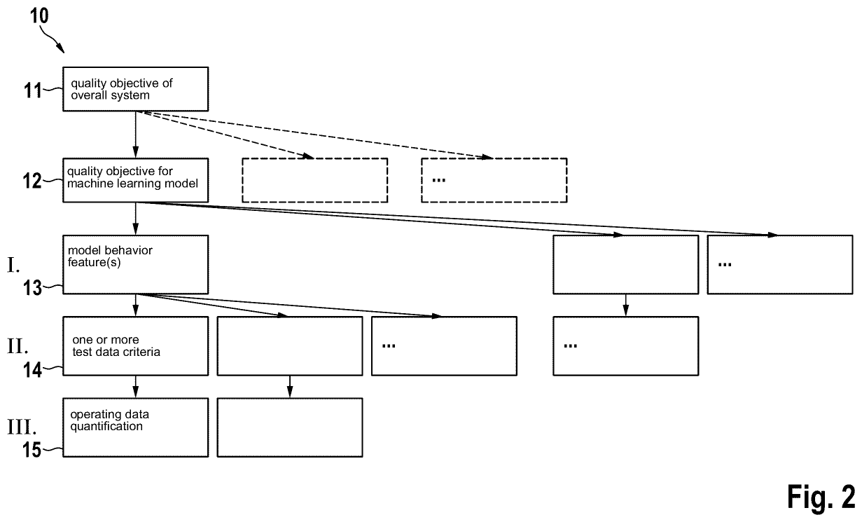

In examples, determining 120 one or more model behavior features 13 can comprise defining one or more model behavior features 13 to be examined as part of the qualification of the ML model. For this purpose, one or more test data criteria 14 can subsequently be defined, by means of which the test dataset is evaluated. As shown in FIG. 2, in examples, the one or more test data criteria 14 can be based on the one or more model behavior features 13. When qualifying the machine learning model, it can be advantageous to assess not only the output result of the machine learning model but also the test dataset with regard to the model behavior feature 13 examined.

In some examples, the method 100 for qualifying a trained machine learning model can be understood as a chain of reasoning. FIG. 2 shows an exemplary qualification matrix 10. In examples, the quality objective 11 of an overall system is to be achieved. The overall system can comprise one or more system components. The machine learning model can be a component of the one or more system components. A quality objective 12 can be specifically defined for the machine learning model. For qualifying the machine learning model, the following method 100 of an embodiment of the present disclosure can be performed. In a first level, the one or more model behavior features 13 can be used to determine whether the machine learning model achieves relevant (desired) functional goals. This can be examined on the basis of a qualified test dataset. In a second level, the evaluation of the test dataset is performed on the basis of the one or more test data criteria 14. For this purpose, one or more reference models can be defined, which can be applied to the test dataset in order to obtain a quantification of the one or more test data criteria 14. In a third level, the inaccuracies in the reference models are analyzed by comparing them with operating data. If necessary, the test dataset can be recreated or adjusted. In examples, the new test dataset can be generated with adapted reference models. This approach can be advantageous to achieve a continuous chain of reasoning for the qualification of the machine learning model.

In examples, one or more test data criteria 14 can be determined for each of the one or more model behavior features 13. In examples, the method can comprise determining 120 multiple model behavior features 13. In this case, different test data criteria 14 can be determined for each of the multiple model behavior features 13. In any case, a different number and type of the one or more test data criteria 14 can be determined for the one or more model behavior features 13. For example, 1, 2, . . . , 10 or more test data criteria 14 can be determined for a first model behavior feature 13, and 1, 2, . . . , 10 or more test data criteria 14 can be determined for a second model behavior feature 13. In examples, the one or more model behavior features can comprise properties of the machine learning model that are aimed at the (desired) function of the machine learning model. In examples, the one or more model behavior features can comprise at least one of an objective function, domain robustness, generalization behavior of the network, input context, or output context. For example, the objective function can be described by a previously defined function of the machine learning model. For example, the objective function can be described by physical model knowledge, by simulation models and/or semantic functional relationships, for example in relation to the overall system. For example, domain robustness can be described by the relationship between the variances of input variables of the machine learning model and the invariances of output variables of the machine learning model. For example, the generalization behavior of the network can be described by the acceptable maximum deviation in comparison to the (test) dataset and/or by the maximum permissible interpolation behavior of the machine learning model. In examples, the input context can be described by previously defined operating ranges of the machine learning model, by safety-critical limits, and/or by distances from known datasets. In examples, the output context can be described by physical limits, by previously defined operating ranges of the machine learning model, by safety-critical limits, and/or by distances from known datasets.

In examples, the one or more test data criteria 14 can comprise at least one of coverage level, input context validity, input distribution, output context validity, output distribution, functional accuracy, concept drift, or dataset dependency.

In examples, the one or more test data criteria can be evaluated by comparing a quantification of the one or more test data criteria on the test dataset with the quantification of the same one or more test data criteria on a dataset of a reference/prototype model. For example, on the basis of the data distribution of the dataset of the reference/prototype, the data distribution of the test dataset can be evaluated as a test data criterion.

In examples, the coverage level can comprise a criterion for describing the content completeness of the test dataset with respect to relevant properties. For example, the coverage level can be evaluated on the basis of a classification, for example with a maximum permissible variance of the respective nearest neighbor points of the output values in the test dataset. In examples, the coverage level can be evaluated on the basis of a percentage. For example, the coverage level can be evaluated on the basis of a percentage of the contents of the test dataset, for example in comparison to a dataset of a prototype/reference model. An example in this respect is traffic scenarios (e.g., weather, roads, lighting, pedestrians) in the case of autonomous driving.

In examples, the input context validity can comprise a criterion for describing the validity of test data input data in the corresponding system context. For example, the validity of the input data of the test dataset can be evaluated by means of known properties in the (input) datasets, e.g., from resampling or unlabeled data. For example, the validity of the input data of the test dataset can be evaluated by the acceptance of exemplary prototype/reference datasets with allowed and/or forbidden data points and/or by means of interpolation and extrapolation rules with respect to existing data points. In examples, physical model knowledge, for example from simulations in relation to the overall system, can also be used to evaluate the validity of the input data in the test dataset in the corresponding system context. In a further example, the validity of the input data in the test dataset can be evaluated by means of a semantic set of rules that can define possible or impossible input data combinations (scenarios). In examples, the input context validity can be evaluated on the basis of a percentage. For example, the input context validity can be evaluated on the basis of a context distribution of the test dataset, for example in comparison to a dataset of a prototype/reference context model. An example in this respect is the operating range of an internal combustion engine.

In examples, the input distribution can comprise a criterion for describing the distribution of the test data input data. For example, the input distribution can be evaluated on the basis of the acceptance of an exemplarily distributed dataset (e.g., from measurements with a known data genesis process), by means of a statistical analysis (e.g., outside temperature distribution), by means of an established domain standard, such as operating points of a standardized driving cycle, and/or legal provisions. In examples, the input distribution can be evaluated on the basis of a Kernel-Stein discrepancy. For example, the input distribution can be evaluated on the basis of a data distribution of the test dataset in comparison to a dataset of a prototype/reference model. An example in this respect is the frequency distribution of wall materials when measuring with a power tool locator, so-called wall scanner.

In examples, the output context validity can comprise a criterion for describing the permissibility of output data of the machine learning function in the corresponding system context. In examples, the output context validity can comprise a criterion for describing the permissibility of test data output data (target values) in the corresponding context of the overall system. For example, the output context validity can be evaluated by means of permissible/impermissible threshold values from safety requirements (e.g., on the basis of physical models). For example, the output context validity can be evaluated by means of the acceptance of exemplary datasets of reference/prototype models with allowed/forbidden output values, interpolation rules and/or extrapolation rules with respect to existing data points. In a further example, the validity of output data can be evaluated by means of a semantic set of rules that can define possible or impossible output data combinations (scenarios).

In examples, the output distribution can comprise a criterion for describing the distribution of output data. In examples, the output data can comprise the target values in the test dataset to be evaluated. For example, the output distribution can be evaluated by means of the acceptance of an exemplarily distributed dataset (e.g., from measurements with a known data genesis process). In examples, the output distribution can be evaluated on the basis of a Kernel-Stein discrepancy. For example, the output distribution can be evaluated on the basis of a data distribution of the test dataset in comparison to a dataset of a prototype/reference model. An example in this respect is the frequency distribution of wall materials when measuring with a power tool locator, so-called wall scanner.

In examples, the functional accuracy can comprise a criterion for the corresponding model behavior feature for describing the content correctness of the output data with respect to an assumed ground truth. For example, the functional accuracy can be evaluated on the basis of the objective function, the domain robustness, the generalization behavior of the network, the input context, and/or the output context.

In examples, the concept drift can comprise a criterion for describing the transferability of a test data domain and/or a training data domain to an operating data domain. For example, the concept drift can be evaluated by means of interpolation on the basis of the test dataset and comparison of the interpolation with labeled operating data. In examples, the concept drift can be evaluated on the basis of a Kernel-Stein discrepancy. For example, the concept drift can be evaluated on the basis of a data distribution of the test dataset in comparison to a dataset of a prototype/reference model. An example in this respect is the data distribution of the test dataset in the vehicle in comparison to a test bench test dataset of a temperature estimation model for the stator temperature of an electric vehicle.

In examples, the dataset dependency can comprise a criterion for describing the dependencies of the test dataset on other datasets, in particular the training dataset.

In examples, the method can comprise determining 140 one or more assessment metrics on the basis of the one or more model behavior features 13. In examples, determining 150 the qualification result can furthermore be based on the one or more assessment metrics. For example, the one or more assessment metrics can comprise a misclassification rate. In examples, the one or more assessment metrics can comprise a confidence interval, for example on the basis of an application-specific metric. In examples, the one or more assessment metrics can comprise a frequency of deviation. For example, the one or more assessment metrics can comprise a frequency of deviation in comparison to a robustness requirement of a reference model, for example a robustness against image rotation of an optical pass-fail part analysis in manufacturing. In examples, the one or more assessment metrics can comprise a deviation. For example, the one or more assessment metrics can comprise a deviation in comparison to functional requirements from a reference model. An example in this respect is the cumulative fuel consumption deviation for a control unit function for estimating the fuel consumption in a vehicle. In examples, the one or more assessment metrics can comprise a mean squared error (MSE).

In examples, the method can comprise using the machine learning model if the qualification result is within an approval range. In examples, the method can comprise using the machine learning model if the one or more assessment metrics are within an approval range. In examples, the qualification result can comprise a separate result for the one or more model behavior features 13 and a separate result for the evaluation of the test dataset. In examples, an approval range can be defined in each case for the one or more model behavior features 13 and for the evaluation of the test dataset. In examples, using the machine learning model can comprise switching from a conventional method to a method based on the machine learning model. In examples, switching can be performed in a computer-implemented manner in an operating environment. In examples, the approval range can comprise one or more first threshold values for the one or more model behavior features 13 and/or one or more second threshold values for the one or more test data criteria 14. For example, the first threshold value for the one or more model behavior features 13 can be a threshold value for the aforementioned misclassification rate.

In examples, the evaluation 130 of the test dataset can comprise defining 131 one or more reference models for one test data criterion each of the one or more test data criteria 14, applying 132 the one or more reference models to the test dataset in order to obtain a test data quantification of at least one test criterion of the one or more test data criteria 14. In examples, the one or more reference models can comprise one or more of a data density estimation and/or data density function, semantic models, principal component analysis, linear interpolation, frequency distribution modeling, k-nearest neighbors classification, and/or nearest neighbor interpolation. For example, the data density estimation can be performed on the basis of given data, on the basis of kernel-based methods, on the basis of histograms, and/or with respect to neighboring points by means of k-nearest neighbors. For example, semantic models can be represented in the form of ontologies and/or rule sets.

For example, for the test data criterion “coverage level,” the one or more reference models can comprise the (test) data density estimation and/or semantic models.

For example, for the test data criterion “input context validity,” the one or more reference models can comprise linear interpolation. In examples, the linear interpolation can be applied to a subspace generated by a principal component analysis. For example, for the test data criterion “input context validity,” the one or more reference models can comprise semantic models. For example, for the test data criterion “input distribution,” the one or more reference models can comprise frequency distribution modeling. In examples, this can comprise partitioning the input data of the machine learning model. For example, for the test data criterion “output context validity,” the one or more reference models can comprise semantic models.

For example, for the test data criterion “output distribution,” the one or more reference models can comprise a data density function.

For example, for the test data criterion “concept drift,” the one or more reference models can comprise a nearest neighbor interpolation and/or a local linear interpolation on the basis of the test dataset, and a comparison of the interpolation with labeled operating data.

In examples, the one or more reference models can be used to quantify the one or more test data criteria. In examples, the quantifications of the one or more test data criteria can be summarized in the test data quantification.

In some embodiments, the test dataset can comprise a first original test dataset and/or a generated test dataset. In examples, the generated test dataset can be generated by applying at least one reference model of the one or more reference models to the first original test dataset. In examples, the generated test dataset can be generated via a selected set from a plurality of second original test datasets. For example, a reference model can comprise generating the test dataset by means of a manifold model and/or an approximated k-nearest neighbors classifier. For example, a reference model for the test criterion “input context validity” can comprise generating the test dataset by means of a manifold model and/or an approximated k-nearest neighbors classifier.

In some embodiments, the method 100 can furthermore comprise applying 160 the one or more reference models to an operating dataset in order to obtain an operating data quantification 15 of at least one test criterion of the one or more test data criteria 14. In some examples, the method can furthermore comprise comparing 170 the test data quantification with the operating data quantification of the at least one test criterion of the one or more test data criteria 14 in order to obtain a comparison result 15. In examples, if the comparison result 15 is outside a defined acceptance range, the method 100 can comprise generating 180 a new test dataset and/or modifying the original test dataset. Furthermore, the method 100 can comprise performing 190 an evaluation of the new test dataset on the basis of the one or more test data criteria 14. In examples, the method 100 can furthermore comprise determining 200 a re-qualification result on the basis of the one or more assessment metrics and the evaluation of the new test dataset. For example, if the comparison result 15 indicates an unacceptable deviation of the operating data from the test dataset, determining 200 the re-qualification result can be necessary to ensure that the machine learning model also provides correct results during operation. In examples, the method 100 can comprise switching from a method based on the machine learning model to a conventional method if the comparison result 15 is outside a defined acceptance range. This can, for example, represent a reverse processing of the previously mentioned method step of switching from a conventional method to a method based on the machine learning model. In examples, applying 160 the one or more reference models to the operating dataset and/or comparing 170 the test data quantification with the operating data quantification can be performed during live operation. For example, this can be done continuously, at certain intervals, multiple times a day and/or by means of a trigger. In examples, applying 160 the one or more reference models to the operating dataset can be part of monitoring the operating data and/or the model behavior in the operating mode.

In examples, at least a subset of the operating dataset can comprise labeled data. For example, for the test criteria “functional accuracy” and/or “concept drift,” the operating dataset can comprise labeled data. For example, for the test criteria “coverage level,” “input context validity,” and/or “input distribution,” labeled data can be unnecessary.

In examples, the method 100 for qualifying the trained machine learning model and/or the (qualified and/or unqualified) machine learning model can be designed to be executed in a vehicle, a robot, a building, a power tool, and/or a household appliance, and/or can be designed to control and/or monitor a vehicle function, a robot function, a building automation function, a power tool automation function, and/or a household appliance automation function. In examples, the method 100 can comprise installing the qualified machine learning model on a computer system in a vehicle, a robot, a building, a power tool, and/or a household appliance.

In examples, a robot can comprise a vehicle (driving in an autonomous or assisted manner). For example, the vehicle function can be a function for autonomous and/or assisted driving. In some examples, the method 100 for qualifying the trained machine learning model and/or the (qualified and/or unqualified) machine learning model can be designed to be executed on a computer system of a vehicle (e.g., a vehicle driving in an autonomous, highly automated, or assisted manner). For example, the computer system can be implemented locally in the vehicle or (at least partially) in a backend that is communicatively connected to the vehicle. For example, the computer system can comprise a control unit on which the method 100 for qualifying the trained machine learning model and/or the machine learning model can be executed. In some examples, the vehicle can comprise a computer system with a communication interface which allows communication with a backend. For example, the method 100 for qualifying the trained machine learning model and/or the machine learning model can be executed in this backend. In examples, control unit functions in vehicles can comprise or access the method 100 for qualifying the machine learning model and/or the machine learning model, for example when they are executed remotely in a cloud. For example, control unit functions that replace physical sensors, calculate correction values and/or abstract system states (such as aging) can comprise or access the method 100 for qualifying the machine learning model and/or the machine learning model, for example when they are executed remotely in a cloud.

In other examples and as indicated above, the method 100 for qualifying the trained machine learning model and/or the (qualified and/or unqualified) machine learning model can be designed to be executed in a robot and/or to control and/or monitor a robot function (in particular, to control and/or monitor a motion function of a robot). In some examples, the method 100 for qualifying the trained machine learning model and/or the machine learning model can be executed on a computer system of a robot. For example, the computer system can be locally implemented in the robot or (at least partially) in a backend that is communicatively connected to the robot.

In one example, the method 100 for qualifying the trained machine learning model and/or the (qualified and/or unqualified) machine learning model can be designed to be executed in a building and/or be used to control building functions (in particular, to control building automation functions). For example, the building function can be a function for controlling room temperature, lighting, and/or safety equipment. In some examples, the method 100 for qualifying the trained machine learning model and/or the machine learning model can be designed to be executed on a computer system within a building. For example, the computer system can be locally implemented in the building or (at least partially) in a backend that is communicatively connected to the building. For example, the computer system can comprise a control system or a building automation control unit on which the method 100 for qualifying the trained machine learning model and/or the machine learning model can be executed. In examples, the building can have a computer system with a communication interface that makes communication with an external backend possible. For example, the method 100 for qualifying the trained machine learning model and/or the machine learning model can be executed in this backend. In examples, input data of the machine learning model and/or operating data can be based on information such as room temperature, brightness, or presence of people. In some cases, input data of the machine learning model and/or operating data can comprise a relative temperature difference, illuminance, or distance to a specific location or object in the building. In examples, information can come from a network, such as sensor data or settings of other buildings or building components. This information can be provided through communication between buildings or parts of buildings or via an external backend.

In other examples, the method 100 for qualifying the trained machine learning model and/or the (qualified and/or unqualified) machine learning model can be designed to be executed in a power tool and/or to control and/or monitor a power tool function (in particular, to control and/or monitor a work function of the power tool). In some examples, the method 100 for qualifying the trained machine learning model and/or the machine learning model can be executed on a computer system of the power tool. For example, the computer system can be locally implemented in the power tool or (at least partially) in a backend that is communicatively connected to the power tool.

In other examples, the method 100 for qualifying the trained machine learning model and/or the (qualified and/or unqualified) machine learning model can be designed to be executed in a household appliance and/or to control and/or monitor a household appliance function (in particular, to control and/or monitor a work function of the household appliance). In some examples, the method 100 for qualifying the trained machine learning model and/or the machine learning model can be executed on a computer system of the household appliance. For example, the computer system can be locally implemented in the household appliance or (at least partially) in a backend that is communicatively connected to the household appliance.

In further examples, the method 100 for qualifying the trained machine learning model and/or the (qualified and/or unqualified) machine learning model can be designed to be executed in a machine tool, a personal assistant, an access control system, and/or a medical device, for example for medical imaging, and/or be accessible via a network. In examples, the method 100 can comprise installing the qualified machine learning model on a computer system of a machine tool, a personal assistant, an access control system, and/or a medical device.

In examples, the machine learning model can be used to analyze audio data and/or video data. In examples, the machine learning model can be used to classify sensor data, to recognize objects, or to semantically segment sensor data, for example with respect to traffic signs, road surfaces, pedestrians, vehicles, electrical lines, water lines, gas lines, biochemical reactions, or physical blockages, for example in path planning. In examples, the machine learning model can be used to determine continuous values, for example by means of regression with respect to distance, velocity, acceleration, gas concentration, azimuth, altitude, fuel consumption, emissions, temperature, current intensity, voltage, aging, yaw rate, humidity, pressure, vibration, and/or cloud cover. In examples, the machine learning model can be used to track objects, for example on the basis of pixel attributes. In further examples, the machine learning model can be used to detect anomalies, optionally by means of an autoencoder. In examples, the machine learning model can be used to estimate sensor signals, in particular sensor signals from a sensor for measuring velocity, rotation rate, current intensity, voltage, temperature, pressure, air pressure, weight, deformation, flow of a liquid or gas, or composition of a gas.

For example, the labeled operating data mentioned above can be obtained by means of sensors. This can mean, for example, that the output signals of a control system are captured by means of sensors so that a labeled operating dataset can be obtained from input data and target data.

A computer system designed to execute the method 100 for qualifying a machine learning model is also disclosed. The computer system can comprise at least one processor and/or at least one working memory. The computer system can furthermore comprise a (non-volatile) memory.

Also disclosed is a computer program designed to execute the method 100 for qualifying a machine learning model. The computer program can be present, for example, in interpretable or in compiled form. For execution, it can (even in parts) be loaded into the RAM of a computer, for example as a bit or byte sequence.

A computer-readable medium or signal that stores and/or contains the computer program or at least a portion thereof is also disclosed. The medium can comprise, for example, any one of RAM, ROM, EPROM, HDD, SDD, . . . , on/in which the signal is stored.

1-15. (canceled)

16. A method for qualifying a trained machine learning model, the method comprising the following steps:
receiving a trained machine learning model;
determining one or more model behavior features;
performing an evaluation of a test dataset based on one or more test data criteria; and
determining a qualification result based on the one or more model behavior features and the evaluation of the test dataset.

17. The method according to claim 16, the method further comprising:
determining one or more assessment metrics based on the one or more model behavior features;
wherein the qualification result is further based on the one or more assessment metrics.

18. The method according to claim 16, further comprising:
using the machine learning model when the qualification result is within an approval range.

19. The method according to claim 18, wherein the approval range includes: (i) one or more first threshold values for the one or more model behavior features and/or (ii) one or more second threshold values for the one or more test data criteria.

20. The method according to claim 18, wherein the using of the machine learning model including switching from a conventional method to a method based on the machine learning model.

21. The method according to claim 16, wherein the evaluation of the test dataset includes:
defining one or more reference models for one test data criterion each of the one or more test data criteri; and
applying the one or more reference models to the test dataset to obtain a test data quantification of at least one test criterion of the one or more test data criteria.

22. The method according to claim 21, wherein the test dataset includes a first original test dataset and/or a generated test dataset, wherein: (i) the generated test dataset is generated by applying at least one reference model of the one or more reference models to the first original test dataset, and/or (ii) the generated test dataset is generated via a selected set from a plurality of second original test datasets.

23. The method according to claim 21, the method further comprising the following steps:
applying the one or more reference models to an operating dataset to obtain an operating data quantification of at least one test criterion of the one or more test data criteria;
comparing the test data quantification with the operating data quantification of the at least one test criterion of the one or more test data criteria to obtain a comparison result, and, when the comparison result is outside a defined acceptance range:
generating a new test dataset and/or modifying the original test dataset,
performing an evaluation of the new test dataset based on the one or more test data criteria, and
determining a re-qualification result based on the one or more assessment metrics and the evaluation of the new test dataset.

24. The method according to claim 23, wherein at least a subset of the operating dataset includes labeled data.

25. The method according to claim 16, wherein the one or more model behavior features include at least one of: an objective function, domain robustness, generalization behavior of a network, input context, output context.

26. The method according to claim 16, wherein the one or more test data criteria include at least one of: coverage level, input context validity, input distribution, output context validity, output distribution, functional accuracy, concept drift, dataset dependency.

27. The method according to claim 16, wherein the method for qualifying the trained machine learning model and/or the machine learning model is configureed to: (i) be executed in a vehicle, and/or a robot, and/or a building, and/or a power tool, and/or a household appliance and/or (ii) to control and/or monitor a vehicle function, and/or a robot function, and/or a building automation function, and/or a power tool automation function, and/or a household appliance automation function.

28. A computer system configured to qualify a trained machine learning model, the computer system configured to:
receive a trained machine learning model;
determine one or more model behavior features;
perform an evaluation of a test dataset based on one or more test data criteria; and
determine a qualification result based on the one or more model behavior features and the evaluation of the test dataset.

29. A non-transitory computer-readable medium on which is stored a computer program including commands for qualifying a trained machine learning model, the commands, when executed by a computer, causing the computer to perform the following steps:
receiving a trained machine learning model;
determining one or more model behavior features;
performing an evaluation of a test dataset based on one or more test data criteria; and
determining a qualification result based on the one or more model behavior features and the evaluation of the test dataset.
